(19) United States
(12) Patent Application Publication
(10) Pub. No.: US 2026/0206003 A1
(43) Pub. Date: Jul. 16, 2026

(54) PHASE ERROR ESTIMATE FOR POSITION DETERMINATION

(71) Applicant: Lenovo (Singapore) Pte. Limited, Singapore (SG)

(72) Inventors: Abir Ben Hadj Fredj, Wiesbaden (DE); Karthikeyan Ganesan, Nauheim (DE); Robin Rajan Thomas, Bad Nauheim (DE); Alexander Golitschek Edler von Elbwart, Darmstadt (DE); Colin Frank, Park Ridge, IL (US)

(73) Assignee: Lenovo (Singapore) Pte. Limited, Singapore (SG)

(21) Appl. No.: 19/136,689

(22) PCT Filed: Dec. 8, 2023
(86) PCT No.: PCT/IB2023/062420

§ 371 Date: Jun. 6, 2025

Related U.S. Application Data
(60) Provisional application No. 63/386,855, filed on Dec. 9, 2022.

(51) Int. Cl. H04W 64/00; H04L 5/00

(52) U.S. Cl. CPC H04W 64/006; H04L 5/0051

(57) ABSTRACT

The present disclosure relates to methods, apparatuses, and systems that support phase error estimate for position determination. For instance, implementations use positioning reference units (PRU) to enable phase error mitigation at target user equipment (UE) by providing assistance data to target UE, such as upon request. Assistance data, for example, can be provided by a network entity (e.g., 1 location management function (LMF)) to a target UE in UE-based scenarios and/or can be directly used by a network entity in UE-assisted and/or LMF-based scenarios.

### TECHNICAL FIELD

This application claims priority to U.S. Provisional Application Ser. No. 63/386,855 filed 9 Dec. 2022 entitled “PHASE ERROR ESTIMATE FOR POSITION DETERMINATION,” the disclosure of which is incorporated by reference herein in its entirety.

### TECHNICAL FIELD

The present disclosure relates to wireless communications, and more specifically to position determination.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for determining position of UEs. However, current techniques for determining UE position may be imprecise.

### SUMMARY

The present disclosure relates to methods, apparatuses, and systems that support phase error estimate for position determination. For instance, implementations use positioning reference units (PRU) to enable phase error mitigation at target UEs by providing assistance data to target UEs, such as upon request. Assistance data, for example, can be provided by a network entity (e.g., LMF) to a target UE in UE-based scenarios and/or can be directly used by a network entity in UE-assisted and/or LMF-based scenarios. Thus, the disclosed techniques provide for accurate error compensation and reduced signalling overhead, which may increase UE position determination accuracy and reduce signaling overhead as compared with current UE positioning techniques.

Some implementations of the methods and apparatuses described herein may further include receiving downlink (DL) positioning reference signal (PRS) over multiple beams received from different transmission-reception points (TRP); generating DL PRS measurements from the DL PRS; processing the DL PRS measurements to estimate phase errors for the multiple beams; and reporting phase error estimates corresponding to each DL PRS measurement received over the multiple beams.

Some implementations of the methods and apparatuses described herein may further include: where the method is performed by a positioning reference unit (PRU); further including reporting the phase error estimate of the phase errors to a network entity; where the network entity includes a location management function (LMF); further including reporting a beam indication for the multiple beams, the beam indication including one or more of beam identifiers, timestamps, or a timer associated with the DL PRS measurements; further including reporting the beam indication to a location management function (LMF) via long term evolution positioning protocol (LPP) signaling; further including receiving a request from a location management function (LMF) for estimated phase errors and reporting the phase error estimate to the LMF via LPP signaling.

Some implementations of the methods and apparatuses described herein may further include: reporting a timer indicating one or more validity times for the one or more of the DL PRS measurements or the estimated phase errors; further including estimating the timer based on information about one or more of oscillator instability, channel conditions, or cycle slips; further including: processing the DL PRS measurements over a period of time to estimate updated phase errors for the multiple beams; and reporting an updated phase error estimate of the updated phase errors; further including reporting the updated phase error estimate of the updated phase errors based at least in part on expiry of a timer; further including processing the DL PRS measurements to estimate the phase errors for the multiple beams based on one or more of initial phase offsets at the TRPs, carrier frequency offsets (CFO), one or more time synchronization errors, one or more frequency synchronization errors, or one or more antenna reference point (ARP) errors.

Some implementations of the methods and apparatuses described herein may further include receiving a phase error estimate including phase errors for multiple beams; and transmitting, to a user equipment (UE), assistance information including the phase errors.

Some implementations of the methods and apparatuses described herein may further include: receiving a request from the UE for assistance information and transmitting the assistance information based at least in part on the request; further including transmitting the assistance information to the UE via LPP signaling; further including: transmitting a request for the phase errors for the multiple beams to a positioning reference unit (PRU); and receiving the phase error estimate from the PRU.

Some implementations of the methods and apparatuses described herein may further include transmitting a request for assistance data for phase error mitigation; receiving the assistance data; and estimating a position of an apparatus based at least in part on the assistance data.

Some implementations of the methods and apparatuses described herein may further include: where the apparatus includes a user equipment (UE); further including: generating DL PRS measurements over multiple beams; and estimating the position of the apparatus via application of the assistance data to the DL PRS measurements; where the assistance data includes estimated phase errors in the DL PRS.

### BRIEF DESCRIPTION OF THE DRAWINGS

FIG. 1 illustrates an example of a wireless communications system that supports phase error estimate for position determination in accordance with aspects of the present disclosure.

FIG. 2 illustrates a scenario presenting an overview of absolute and relative positioning scenarios.

FIG. 3 illustrates a scenario for a multi-cell RTT positioning.

FIG. 4 illustrates a scenario for relative range estimation using an existing single gNB RTT positioning framework.

FIG. 5 illustrates a scenario for NR beam-based positioning.

FIG. 6 illustrates a scenario that supports phase error estimate for position determination in accordance with aspects of the present disclosure.

FIG. 7 illustrates a scenario that supports phase error estimate for position determination in accordance with aspects of the present disclosure.

FIGS. 8 and 9 illustrate examples of block diagrams of devices that support phase error estimate for position determination in accordance with aspects of the present disclosure.

FIGS. 10 through 12 illustrate flowcharts of methods that support phase error estimate for position determination in accordance with aspects of the present disclosure.

### DETAILED DESCRIPTION

In some wireless communications systems, there is currently a lack of support for RAT-dependent carrier phase-based positioning. For instance, increased positioning accuracy for certain scenarios could be achieved using a carrier phase-based positioning technique. However, current positioning techniques experience challenges, such as when phase error sources (e.g., initial phase offset, time and frequency synchronization errors, carrier frequency offset CFO, Antenna reference points ARPs, Doppler velocity, etc.) are not correctly mitigated. Thus, current wireless communications systems may be unable to accurately and efficiently utilize carrier phase-based positioning for determining UE position.

Accordingly, this disclosure provides for techniques that support phase error estimate for position determination. For instance, implementations use PRUs to enable phase error mitigation at target UEs by providing assistance data to target UEs, such as upon request. Assistance data, for example, can be provided by a network entity (e.g., LMF) to a target UE in UE-based scenarios and/or can be directly used by a network entity in UE-assisted and/or LMF-based scenarios. Thus, the disclosed techniques provide for accurate error compensation and reduced signalling overhead, which may increase UE position determination accuracy and reduce signaling overhead as compared with current UE positioning techniques.

In implementations, a network entity (e.g., LMF) requests that a PRU perform DL PRS measurements over different DL PRS beams received from different TRPs. The PRU can receive DL PRS beams and measure attributes of the beams. In implementations, a request message from the network entity and/or PRU estimates and data can be transmitted via LPP signalling. Based at least in part on measurements of the DL PRS beams, a PRU can determine phase error estimates and/or integer ambiguity ranges. A PRU, for instance, transmits (e.g., in an LPP message such as “ProvidePRUData”) to a network entity the estimated phase errors and/or integer ambiguity ranges associated with each of the beam identifiers (ID) of the measured DL PRS beams. In implementations, each of these estimates can be reported with a timestamp, DL PRS beam information, and/or a timer. Further, phase error estimates can be tracked over time and updated, such as after expiry of a timer.

In implementations, a target UE can request PRU assistance information by transmitting an assistance request to a network entity (e.g., LMF) for information for compensating for phase errors, such as due to initial phase offsets, CFOs, time synchronization errors, frequency synchronization errors, cycle slips, range of a cycle period, and providing DL PRS beam information to assist selecting PRUs served by a beam. Accordingly, a target UE can perform DL PRS measurements to determine its position using carrier phase-based positioning techniques. For instance, the target UE estimates the carrier phase of the received signal and the carrier phase estimates at the target UE can be impacted by several phase errors sources. To compensate for these errors and more accurately estimate a position of the target UE, the target UE requests assistance data from a network entity, receives the assistance data, and uses the assistance data as part of carrier phase-based positioning to accurately estimate a position of the target UE.

Thus, by utilizing the described techniques, accurate determination of device position is enabled and signaling overhead as part of device positioning is reduced.

Aspects of the present disclosure are described in the context of a wireless communications system. Aspects of the present disclosure are further illustrated and described with reference to device diagrams and flowcharts.

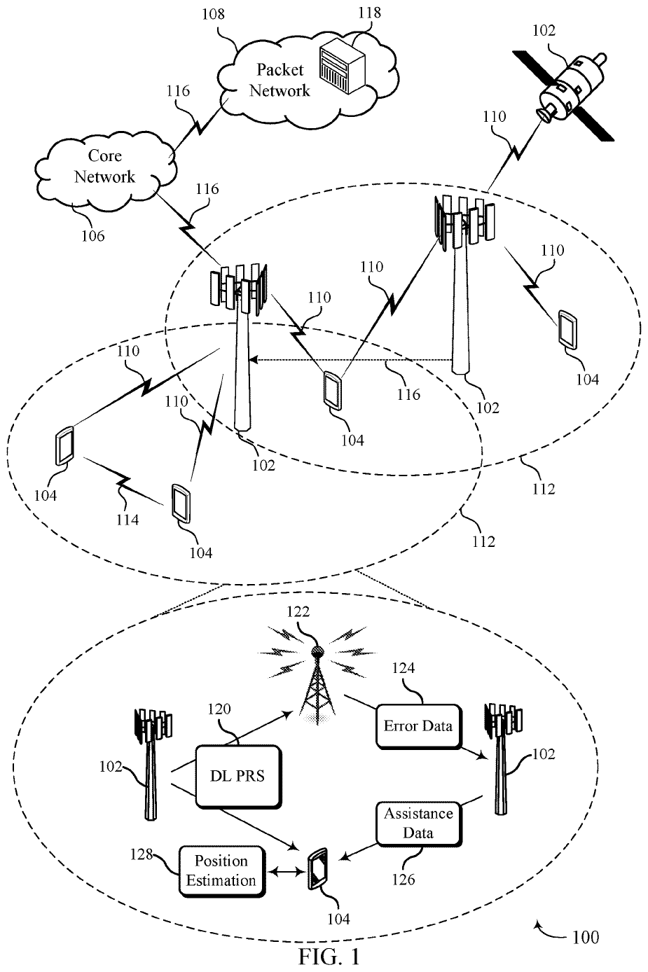

FIG. 1 illustrates an example of a wireless communications system 100 that supports phase error estimate for position determination in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for phase error estimate for position determination, a network entity 102 (e.g., a base station such as a gNB) transmits DL PRS 120 which can be received by a PRU 122 and a target UE 104. The PRU 122 generates error data 124 and transmits the error data 124 to a network entity 102, e.g., an LMF. The error data 124, for instance, includes data such as estimated phase errors and/or integer ambiguity ranges for multiple beams of the DL PRS 120. The network entity 102 processes the error data 124 to generate assistance data 126 and transmits the assistance data 126 to a target UE 104. The assistance data 126, for example, includes the estimated phase errors and/or integer ambiguity ranges for multiple beams of the DL PRS 120, such as described in the error data 124. Accordingly, the target UE 104 can utilize the assistance data 126 to execute position estimation 128 to estimate a position of the target UE 104. The position estimation 128 can estimate a position of the target UE 104 in various ways, such as geographic position (e.g., Global Positioning System (GPS) coordinates), network position (e.g., relative to different network entities 102), and so forth.

In some wireless communications systems, NR positioning based on NR Uu signals and standalone (SA) architecture (e.g., beam-based transmissions) are specified such as specified in Rel-16. The targeted use cases include commercial and regulatory (emergency services) scenarios such as as in Rel-15. The performance requirements include the following in Table 1:

TABLE 1

| Positioning Error | Indoor | Outdoor |
|---|---|---|
| Horizontal | <3 m for 80% | <10 m for 80% |
| Positioning | of UEs | of UEs |
| Vertical | <3 m for 80% | <3 m for 80% |
| Positioning | of UEs | of UEs |

Current 3GPP Rel-17 Positioning has recently defined the positioning performance requirements for Commercial and IIoT use cases as follows in Table 2:

TABLE 2

| Positioning Error | Commercial | IIoT |
|---|---|---|
| Horizontal | (<1 m) for 90% | (<0.2 m) for 90% |
| Positioning | of UEs | of UEs; |
| Vertical | (<3 m) for 90% | (<1 m) for 90% |
| Positioning | of UEs | of UEs |
| Physical layer | (<10 ms) | (<10 ms) |
| latency for | | |
| position estimation | | |
| of UE | | |
| End-to-End Latency | (<100 ms) | (<100 ms, in the |
| for position | | order of 10 ms |
| estimation | | is desired) |
| of UE | | |

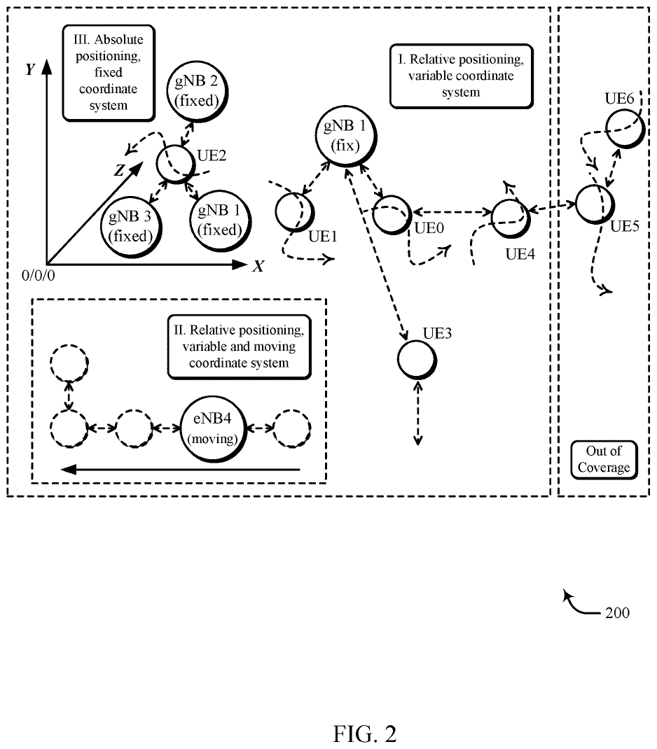

FIG. 2 illustrates a scenario 200 presenting an overview of absolute and relative positioning scenarios. The scenario 200, for includes positioning scenarios as defined in the architectural (stage 1) specifications using three different co-ordinate systems: Absolute Positioning, fixed coordinate systems; Relative Positioning, variable and moving coordinate system; and Relative Positioning, variable coordinate system.

In some wireless communications systems, the following RAT-dependent positioning techniques are supported:

Downlink Time Difference Of Arrival (DL-TDoA): The DL-TDOA positioning method makes use of the DL Reference Signal Time Difference (RSTD) (and optionally DL PRS Reference Signal Received Power (RSRP)) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

DL-AoD: The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multi-Round Trip Time (RTT): The Multi-RTT positioning method makes use of the UE Rx-Tx measurements and DL PRS RSRP of downlink signals received from multiple TRPs, measured by the UE and the measured gNB Rx-Tx measurements and uplink (UL) Sounding Reference Signal (SRS)-RSRP at multiple TRPs of uplink signals transmitted from UE.

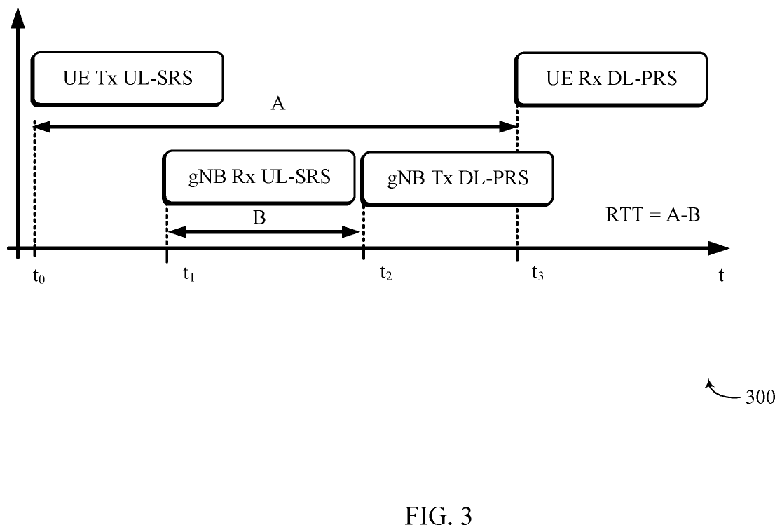

FIG. 3 illustrates a scenario 300 for a multi-cell RTT positioning. For instance, the UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE.

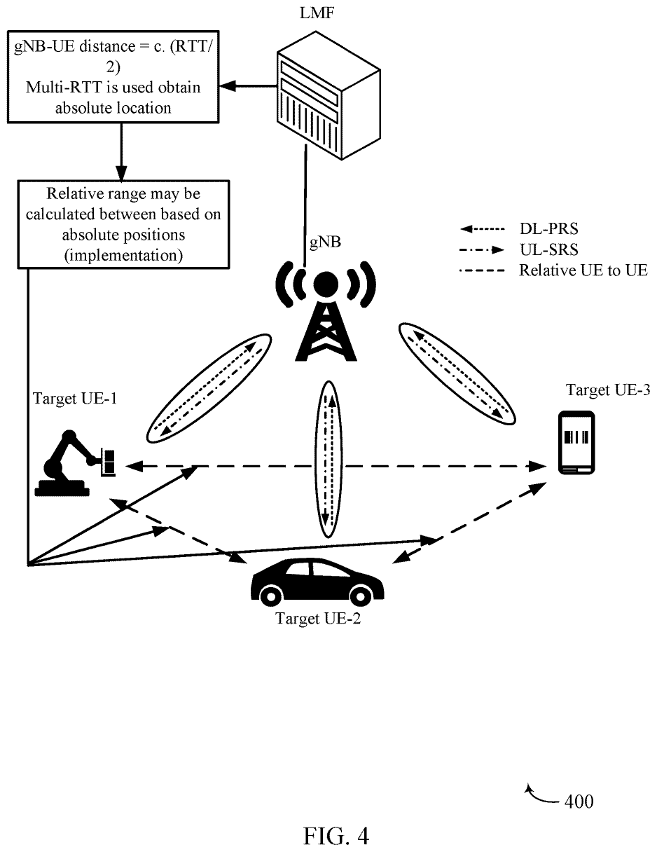

FIG. 4 illustrates a scenario 400 for relative range estimation using an existing single gNB RTT positioning framework.

In some wireless communications systems, for carrier phase based positioning (CPP) (e.g., in Rel.16 [Technical Specification (TS) 38.855]), an NR carrier-phase based positioning technique is proposed. For instance, CPP represents a positioning method where the transmitter (either the gNB or the UE) transmits the positioning reference signals at the pre-configured carrier frequency, and the receiver (either the UE or the gNB) obtains the carrier phase measurements by tracking reference signals. For instance, phase measurements are derived from the complex correlations at the receiver side. The measurements combined with TDOA are used to estimate user position.

In an enhanced Cell ID (CID) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E CID) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; e.g., the positioning procedures do not supply a measurement configuration or measurement control message, and the UE reports the measurements that it has available rather than being required to take additional measurement actions.

An UL TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

The UL AoA positioning method makes use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

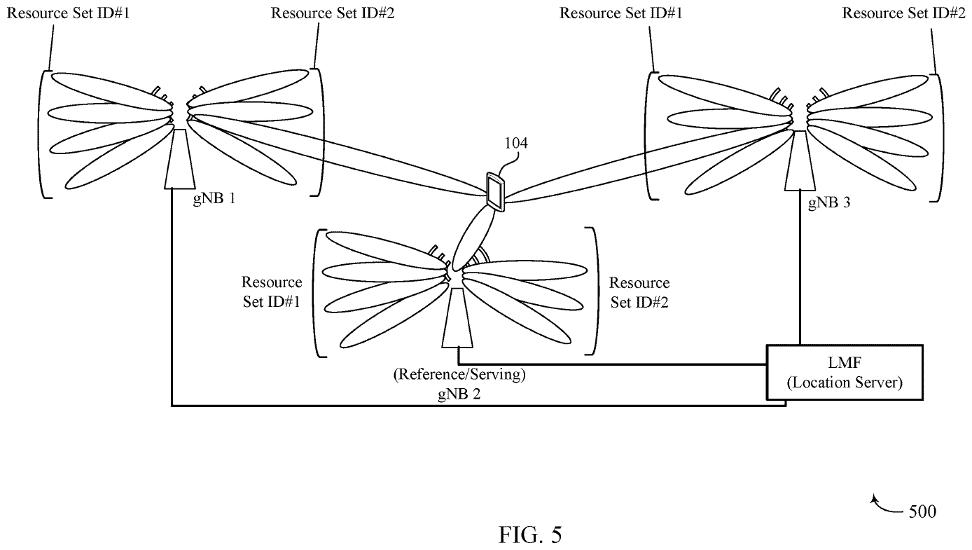

FIG. 5 illustrates a scenario 500 for NR beam-based positioning. The scenario 500 includes different PRS resource sets transmitted by different gNB and that can be receive by a UE 104 for purposes of determining a position of the UE 104. For instance, in at least some scenarios, PRS can be transmitted by the different base stations (serving and neighboring) using narrow beams over FR1 and FR2 as illustrated in the scenario 500. The PRS can be locally associated with a PRS Resource ID and Resource Set ID for a base station (e.g., TRP). Further, UE positioning measurements such as RSTD and PRS RSRP measurements can be made between beams (e.g., between a different pair of DL PRS resources or DL PRS resource sets) as opposed to different cells as was the case in LTE. In addition, there are additional UL positioning methods for the network to exploit in order to compute the target UE's location. Table 3 and Table 4 below illustrate reference signal to measurements mapping for RAT-dependent positioning techniques at the UE and gNB, respectively. RAT-dependent positioning techniques may involve the 3GPP RAT and core network entities to perform the position estimation of the UE, which are differentiated from RAT-independent positioning techniques which rely on Global Navigation Satellite System (GNSS), inertial measurement unit (IMU) sensor, wireless local access network (WLAN) and Bluetooth technologies for performing target device (UE) positioning.

TABLE 3
UE Measurements to enable RAT-dependent
positioning techniques

| | | To facilitate |
|---|---|---|
| | | support of the |
| | | following |
| DL/UL Reference | | positioning |
| Signals | UE Measurements | techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/ | UE Rx − Tx time | Multi-RTT |
| Rel. 16 SRS for | difference | |
| positioning | | |
| Rel. 15 SSB/CSI-RS | SS-RSRP(RSRP for | E-CID |
| for Radio Resource | RRM), SS-RSRQ(for | |
| Management (RRM) | RRM), CSI-RSRP (for | |
| | RRM), CSI-RSRQ (for | |
| | RRM), SS-RSRPB | |
| | (for RRM) | |

TABLE 4
gNB Measurements to enable RAT-
dependent positioning techniques

| | | To facilitate |
|---|---|---|
| | | support of the |
| | | following |
| DL/UL Reference | | positioning |
| Signals | gNB Measurements | techniques |
| Rel. 16 SRS for | UL RTOA | UL-TDOA |
| positioning | | |
| Rel. 16 SRS for | UL SRS-RSRP | UL-TDOA, UL-AoA, |
| positioning | | Multi-RTT |
| Rel. 16 SRS for | gNB Rx − Tx time | Multi-RTT |
| positioning, | difference | |
| Rel. 16 DL PRS | | |
| Rel. 16 SRS for | AoA and ZoA | UL-AoA, Multi-RTT |
| positioning, | | |

Aspects of DL PRS sequence generation and mapping to physical resources include the following: A positioning frequency layer consists of one or more downlink PRS resource sets, each of which consists of one or more downlink PRS resources as described in [6, TS 38.214].

For sequence generation, a UE can assume the reference-signal sequence r(m) is defined by

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

where the pseudo-random sequence c(i) is defined in clause 5.2.1. The pseudo-random sequence generator can be initialised with

$${c}_{init} = ( {2}^{22} ⌊ \frac{{n}_{ID , s e q}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31}$$

where

$${n}_{s , f}^{μ}$$

is the slot number, the downlink PRS sequence ID

$${n}_{ID , seq}^{RRS} ∈ \{ 0 , 1 , … , 4095 \}$$

is given by the higher-layer parameter dl-PRS-SequenceID, and l is the OFDM symbol within the slot to which the sequence is mapped.

For double differential techniques in GNSS, the position of a fixed GNSS receiver, referred to as a base station, can be determined to a high degree of accuracy using conventional surveying techniques. Then, the base station determines ranges to the GNSS satellites in view using:
The code-based positioning technique described in Chapter 2.
The location of the satellites determined from the precisely known orbit ephemerides and satellite time.

The base station compares the surveyed position to the position calculated from the satellite ranges. Differences between the positions can be attributed to satellite ephemeris and clock errors, but mostly to errors associated with atmospheric delay. The base station sends these errors to other receivers (rovers), which incorporate the corrections into their position calculations. Differential positioning uses a data link between the base station and rovers, if corrections need to be applied in real-time, and at least four GNSS satellites in view at both the base station and the rovers.

For RAT-dependent positioning measurements, different DL measurements including DL PRS-RSRP, DL RSTD and UE Rx-Tx Time Difference used for the supported RAT-dependent positioning techniques are shown in Table 5 below. For instance, the following measurement configurations are specified [TS38.215]:
4 Pair of DL RSTD measurements can be performed per pair of cells. Each measurement is performed between a different pair of DL PRS Resources/Resource Sets with a single reference timing.
8 DL PRS RSRP measurements can be performed on different DL PRS resources from the same cell.

TABLE 1
DL Measurements required for DL-based positioning methods [TS38.215]
DL PRS reference signal received power (DL PRS-RSRP)

| | |
|---|---|
| Definition | DL PRS reference signal received power (DL PRS-RSRP), is defined as the |
| | linear average over the power contributions (in [W]) of the resource elements |
| | that carry DL PRS reference signals configured for RSRP measurements within |
| | the considered measurement frequency bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than the |
| | corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for the |
| | DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} measurement |
| | shall be the Tx antenna connector of the UE. For frequency range 2, the |
| | reference point for T_{UE-RX} measurement shall be the Rx antenna of the UE and |
| | the reference point for T_{UE-TX} measurement shall be the Tx antenna of the UE. |
| Applicable for | RRC_CONNECTED intra-frequency |
| | RRC_CONNECTED inter-frequency |

Accordingly, solutions are provided in this disclosure for efficient use of PRUs for mitigating phase error sources allowing for accurate carrier phase measurements. For instance, PRUs can perform measurements over DL PRS transmitted by TRPs to enable phase error estimation and mitigation as well as reduce integer ambiguity search space and thus reduce integer ambiguity. Phase errors estimates and integer ambiguity ranges collected by the positioning reference units can be transmitted to a network entity (e.g., LMF) prior, during, and/or after positioning carrier phase measurements and tracked and updated regularly. Further, each of the phase error estimates can be associated with a beam ID, a timestamp, a timer, etc. Measurements for phase error estimates can be initial phase offset at a TRP and/or a target UE, and/or other measurement needed for mitigating error sources such as time and frequency synchronization errors, doppler velocity, residual CFO, antenna reference point errors, etc. In implementations, phase error estimates can be provided (e.g., upon request) to target UEs, such as designated by an LMF based on PRU-target UE distance.

In implementations, a condition for a target UE is that TRP-UE Tx beams and TRP-PRU Tx beam used for PRS resource transmissions and measurements at PRU side are to be QCled with a same Synchronization Signal Block (SSB) beam to have equivalent channel conditions for both DL PRS measurements. Thus, phase error estimates can be provided (e.g., upon request) to a target UE to determine the target UEs' position, such as for error compensation and/or integer ambiguity resolution. In implementations, the disclosed implementations reduce signalling overhead, such as by collecting phase error estimates from PRUs prior, during, and/or after positioning carrier phase measurements, and providing the carrier phase error estimates to target UEs. For instance, the carrier phase error estimates can be provided via an LPP “ProvideAssistanceData” message to target UEs upon request in a UE-based scenario. A target UE, for example, can request carrier phase error estimates via an LPP “RequestAssistanceData” message. In UE-assisted scenarios, carrier phase error estimates can be used by a network entity to compensate for errors and determine target UE location.

In implementations, a network entity can transmit a “RequestPRUData” message to PRUs indicating the requested phase error estimates for example measurements related to error mitigation such as initial phase offsets at TRPs, measurements related to integer ambiguity resolution, etc. Accordingly, PRUs can perform measurements over DL PRS transmitted from different TRPs and can report these measurements received over different beam IDs. Further, the PRUs can report a timestamp and a timer associated with the phase error estimates. This data can be collected by a network entity and transmitted upon request to target UEs and/or used by the network to compensate errors and resolve integer ambiguity. Phase error estimates can be updated, such as after expiry of a timer. In implementations, the described techniques enable a reduced signalling overhead, such as by enabling phase error estimates to be used by multiple target UEs receiving DL PRS to compensate for phase errors in beams received from a same TRP. In implementations, phase error information can be provided by a network entity to a target UE based on a target UE request for a one-shot carrier phase estimation.

In implementations, a positioning-related reference signal may be referred to as a reference signal used for positioning procedures and/or purposes to estimate a target-UE location (e.g., PRS), and/or based on existing reference signals such as channel state information (CSI) reference signal (RS), SRS, or a reference signal for carrier phase positioning. Further, a target-UE may be referred to as a device and/or entity to be localized and/or positioned. In implementations, the term ‘PRS’ may refer to a signal such as a reference signal which may or may not be used primarily for positioning.

In implementations, PRUs can perform DL PRS measurements over different PRS resources (e.g., beams) from different TRPs and estimate phase errors and/or integer ambiguity ranges of the PRS resources. The PRUs can report the estimates and/or integer ambiguity ranges to network entities along with timestamps, beam IDs, and/or timers. Further, based on requests from target UEs, phase error estimates and/or integer ambiguity ranges can be transmitted from a network entity to target UEs, such as via LPP signalling. According to implementations, values for phase errors and/or integer ambiguity ranges are tracked and updated upon expiry of a timer. The timer, for instance, can be estimated based on factors such as oscillator instability, receiver dynamics, channel conditions, etc.

In implementations, a network entity (e.g., LMF) can select PRUs for providing estimated phase errors and/or integer ambiguity ranges to target UEs based on various factors, such as PRU and target UE and/or TRP distance, channel conditions (e.g., line of sight (LOS) and/or non-LOS (NLOS)), PRU density, etc. For instance, a network entity can transmit a “RequestPRUData” message to each of the selected PRU candidates to request one or more phase errors estimates. The PRU candidates can perform measurements over DL PRS transmitted from different TRPs over different beams and report measurements and/or phase errors estimates associated with each beam ID to the network entity. The phase error estimates can include initial phase offsets at a transmitter (e.g., gNB and/or target UE) and/or receiver (e.g., gNB and/or target UE), and may also include time synchronization errors, frequency synchronization errors, doppler velocity, ARP errors, and residual CFO, or combinations thereof, such as for error compensation and integer ambiguity ranges for integer ambiguity resolution. In implementations, with knowledge of PRU and TRP coordinates with low uncertainty levels, the phase errors and/or other errors such as discussed above can be calculated and the phase error estimates can be reported (e.g., transmitted) to a network entity.

In implementations, phase error estimates and PRS measurements can reported to a network entity tagged with a beam ID, timestamp, a timer, etc. The timer, for instance, indicates that a measurement is valid for a period of time indicated by timer t. As an example, if a measurement is a transmitter initial phase offset, the timer can indicate a period until a transmitter oscillator instability impacts a measurement value, and a new phase offset is to be determined. In another example, when a measurement is an integer ambiguity range, a timer can indicate a period until a cycle slip occurs. In implementations, timer values can be calculated based on models that include parameters such as receiver dynamics, channel conditions, UE mobility, etc. Thus, integer ambiguity can be resolved again, and a new integer ambiguity value can be reported to a network entity.

In implementations for UE-assisted scenarios, assistance data can be transmitted to a network entity, e.g., LMF. Further, the network entity (e.g., based on request from a target UE) communicates the assistance data as part of assistance information to a target UE. For instance, prior, during, and/or after a positioning session, a network entity collects measurements from PRUs. The measurements can include initial phase offsets of a gNB, integer ambiguity values, measurements for calibrating frequency and time synchronisation errors, and/or combinations thereof. The measurements can be broadcast to target UEs (e.g., upon request), such as to enable the target UEs to compensate for errors and resolve integer ambiguity at the UE side for determining target UE position.

In implementations, a PRU can be configured by a network entity (e.g., LMF) to report phase differences between two TRPs associated with two beam IDs. The phase differences, for example, can be used at the network entity to mitigate initial phase error at a PRU and/or other phase error at a PRU, and subtract the phase difference from phase error estimates used to compensate for errors at a target UE. Differencing technique can be performed at a PRU to compensate for PRU phase errors prior to carrier phase errors estimation, such as to enable mitigation of PRU phase errors in carrier phase errors estimation.

In implementations, carrier phase estimate corresponding to the LOS path, at PRU side can be expressed as follows:

$${φ}_{PRU} = \frac{f}{c} ( {d}_{TRP - PRU} + 2 π N ) + {φ}_{e}$$

Where f is carrier frequency, c is speed of light, d_{TRP-PRU} is distance between TRP and PRU, N is integer ambiguity and φₑ are error sources (including initial phase offsets, CFOs, time/frequency synchronization errors, ARP errors and any other error source impacting the received carrier phase) that may impact carrier phase estimate.

In implementations, using the PRU and TRP coordinates, an integer ambiguity value and the carrier phase can be estimated and an estimate of the range between PRU and TRP can be determined. A difference between actual carrier phase (e.g., calculated based on real distance d between PRU and TRP) and estimated carrier phase can be attributed to carrier phase errors. In at least one implementation, phase error estimates can be transmitted directly to target UEs for real-time error corrections. Further, direct PC5 link between a PRU and a target UE can be utilized for an out-of-coverage scenario. Phase error measurements can be transmitted to a network entity and broadcast to target UEs for phase errors compensation.

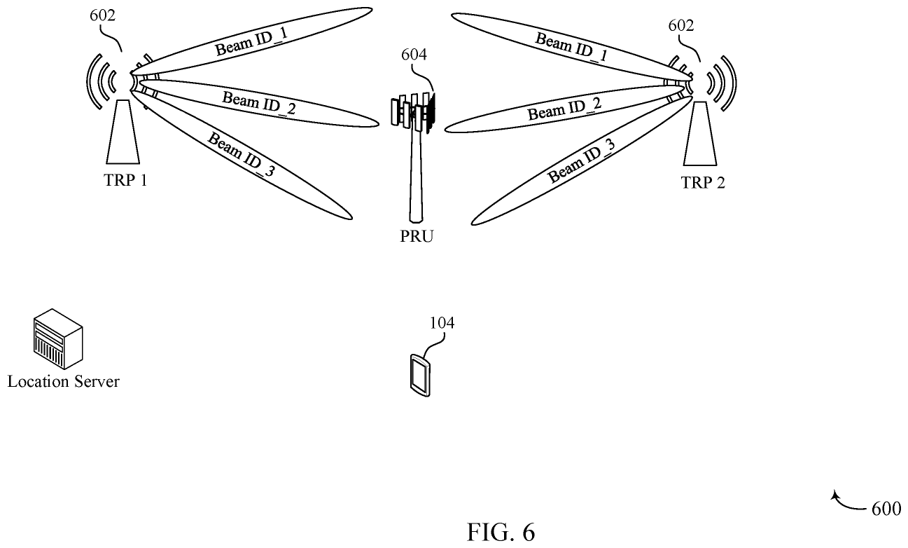

FIG. 6 illustrates a scenario 600 that supports phase error estimate for position determination in accordance with aspects of the present disclosure. The scenario 600, for example, depicts performing DL PRS measurements over different beams for different TRPs. For instance, in the scenario 600, TRPs 602 (e.g., gNBs) transmit beams and a PRU 604 receives the beams and performs DL PRS measurements.

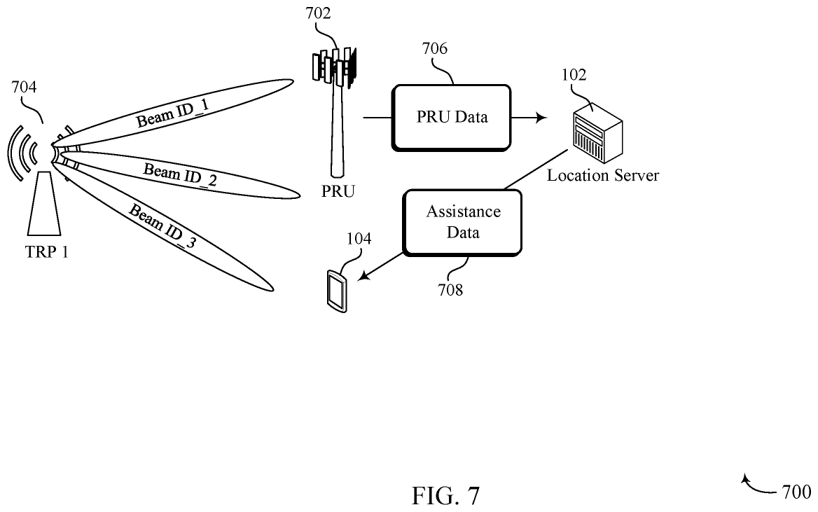

FIG. 7 illustrates a scenario 700 that supports phase error estimate for position determination in accordance with aspects of the present disclosure. In the scenario 700 a PRU 702 receives beams (e.g., DL PRS signal) from a TRP 704 and generates PRU data 706. The PRU data 706, for instance, includes estimated phase errors from the beams received from the TRP 704. The PRU 702 reports (e.g., transmits) the PRU data 706 to a network entity 102, e.g., a location server such as an LMF. The network entity 102 generates assistance data 708 and transmits the assistance data 708 to a UE 104. The UE 104 can utilize the assistance data 708 to estimate a position of the UE 104, such as described throughout this disclosure.

Accordingly, in implementations, each PRU receives DL PRS over a Tx beam associated with a beam ID. Each PRU can perform measurements such as detailed above and report the phase error estimates associated with each beam ID. The phase error estimates enable each of the target UEs to accurately estimate the carrier phase and thus accurately estimate its position. Based on a target UE request, phase error estimate values can be transmitted to the target UE as assistance data 708 to assist the target UE in compensating for phase errors and resolving integer ambiguity.

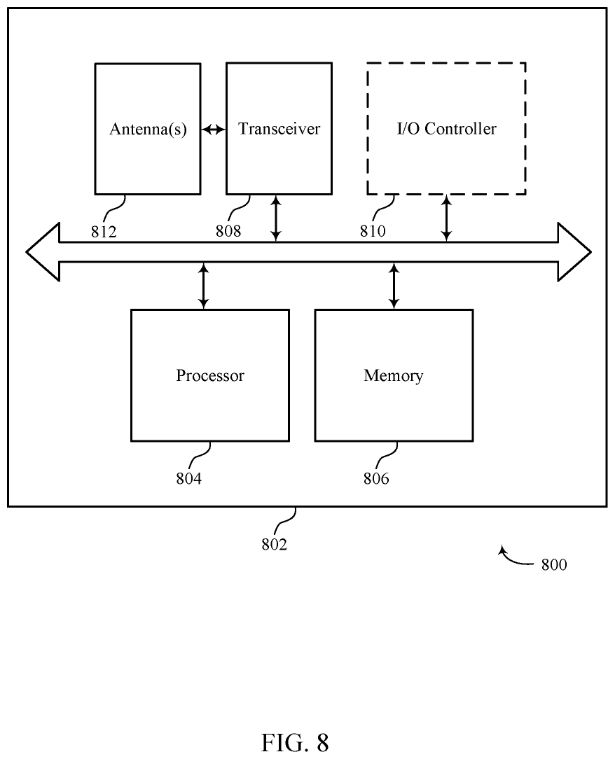

FIG. 8 illustrates an example of a block diagram 800 of a device 802 (e.g., an apparatus) that supports phase error estimate for position determination in accordance with aspects of the present disclosure. The device 802 may be an example of UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of UE 104, for example, the transceiver 808 and the processor coupled 804 coupled to the transceiver 808 are configured to cause the UE 104 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as and/or otherwise support a means to transmit a request for assistance data for phase error mitigation; receive the assistance data; and estimate a position of the apparatus based at least in part on the assistance data.

Further, in some implementations, the apparatus includes a user equipment (UE); the processor is configured to cause the apparatus to: generate DL PRS measurements over multiple beams; and estimate the position of the apparatus via application of the assistance data to the DL PRS measurements; the assistance data includes estimated phase errors in the DL PRS.

The processor 804 of the device 802, such as a UE 104, may support wireless communication in accordance with examples as disclosed herein. The processor 804 includes at least one controller coupled with at least one memory, and the at least one controller is configured to and/or operable to cause the processor 804 to transmit a request for assistance data for phase error mitigation; receive the assistance data; and estimate a position of a UE based at least in part on the assistance data. Further, the at least one controller is configured to and/or operable to cause the processor 804 to perform the various operations described herein, such as with reference to a UE 104 and/or the device 802.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M08. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

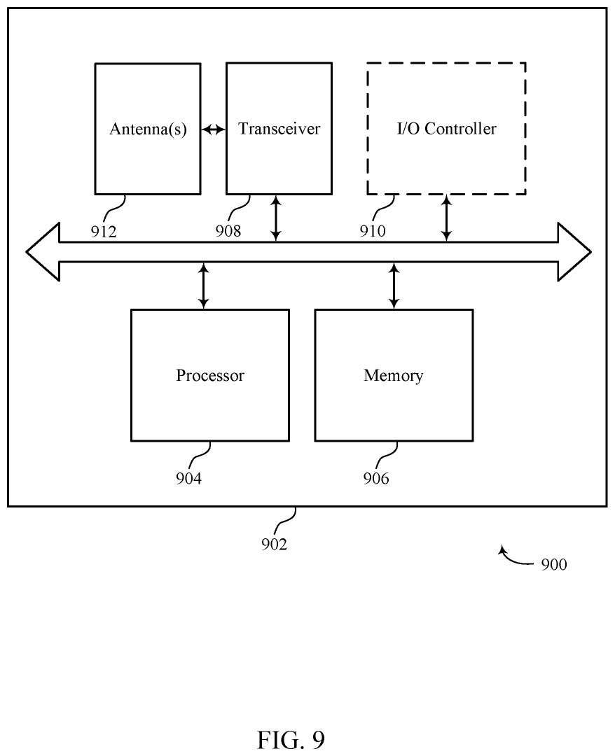

FIG. 9 illustrates an example of a block diagram 900 of a device 902 (e.g., an apparatus) that supports phase error estimate for position determination in accordance with aspects of the present disclosure. The device 902 may be an example of a network entity 102 (e.g., an LMF, a roadside unit (RSU), etc.) as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906). In the context of network entity 102, for example, the transceiver 908 and the processor 904 coupled to the transceiver 908 are configured to cause the network entity 102 to perform the various described operations and/or combinations thereof.

For example, the processor 904 and/or the transceiver 908 may support wireless communication at the device 902 in accordance with examples as disclosed herein. For instance, the processor 904 and/or the transceiver 908 may be configured as or otherwise support a means to receive DL PRS over multiple beams received from different transmission-reception points (TRP); generate DL PRS measurements from the DL PRS; process the DL PRS measurements to estimate phase errors for the multiple beams; and report phase error estimates corresponding to each DL PRS measurement received over the multiple beams.

Further, in some implementations, the apparatus includes a positioning reference unit (PRU); the processor is configured to cause the apparatus to report the phase error estimate of the phase errors to a network entity; the network entity includes a location management function (LMF); the processor is configured to cause the apparatus to report a beam indication for the multiple beams, the beam indication including one or more of beam identifiers, timestamps, or a timer associated with the DL PRS measurements; the processor is configured to cause the apparatus to report the beam indication to a location management function (LMF) via LPP signaling; the processor is configured to cause the apparatus to receive a request from a location management function (LMF) for estimated phase errors, and to report the phase error estimate to the LMF via LPP signaling.

Further, in some implementations, the processor is configured to cause the apparatus to report a timer indicating one or more validity times for the one or more of the DL PRS measurements or the estimated phase errors; the processor is configured to cause the apparatus to estimate the timer based on information about one or more of oscillator instability, channel conditions, or cycle slips; the processor is configured to cause the apparatus to: process the DL PRS measurements over a period of time to estimate updated phase errors for the multiple beams; and report an updated phase error estimate of the updated phase errors; the processor is configured to cause the apparatus to report the updated phase error estimate of the updated phase errors based at least in part on expiry of a timer; the processor is configured to cause the apparatus to process the DL PRS measurements to estimate the phase errors for the multiple beams based on one or more of initial phase offsets at the TRPs, CFO, one or more time synchronization errors, one or more frequency synchronization errors, or one or more ARP errors.

In a further example, the processor 904 and/or the transceiver 908 may support wireless communication at the device 902 in accordance with examples as disclosed herein. The processor 904 and/or the transceiver 908, for instance, may be configured as or otherwise support a means to receive a phase error estimate including phase errors for multiple beams; and transmit, to a user equipment (UE), assistance information including the phase errors.

Further, in some implementations, the processor is configured to cause the apparatus to receive a request from the UE for assistance information and transmit the assistance information based at least in part on the request; the processor is configured to cause the apparatus to transmit the assistance information to the UE via LPP signaling; the processor is configured to cause the apparatus to: transmit a request for the phase errors for the multiple beams to a positioning reference unit (PRU); and receive the phase error estimate from the PRU.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor M06. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (e.g., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

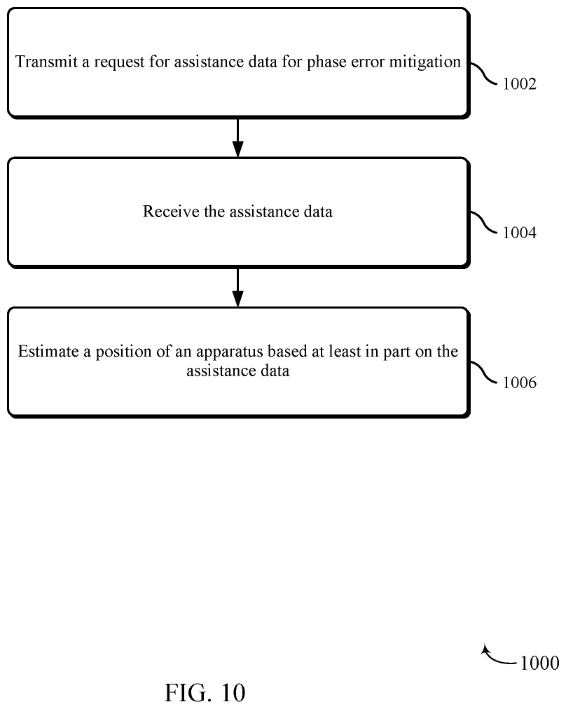

FIG. 10 illustrates a flowchart of a method 1000 that supports phase error estimate for position determination in accordance with aspects of the present disclosure. The operations of the method 1000 may be implemented by a device or its components as described herein. For example, the operations of the method 1000 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1002, the method may include transmitting a request for assistance data for phase error mitigation. The operations of 1002 may be performed in accordance with examples as described herein. In some implementations, aspects of the operations of 1002 may be performed by a device as described with reference to FIG. 1.

At 1004, the method may include receiving the assistance data. The operations of 1004 may be performed in accordance with examples as described herein. In some implementations, aspects of the operations of 1004 may be performed by a device as described with reference to FIG. 1.

At 1006, the method may include estimating a position of an apparatus based at least in part on the assistance data. The operations of 1006 may be performed in accordance with examples as described herein. In some implementations, aspects of the operations of 1006 may be performed by a device as described with reference to FIG. 1.

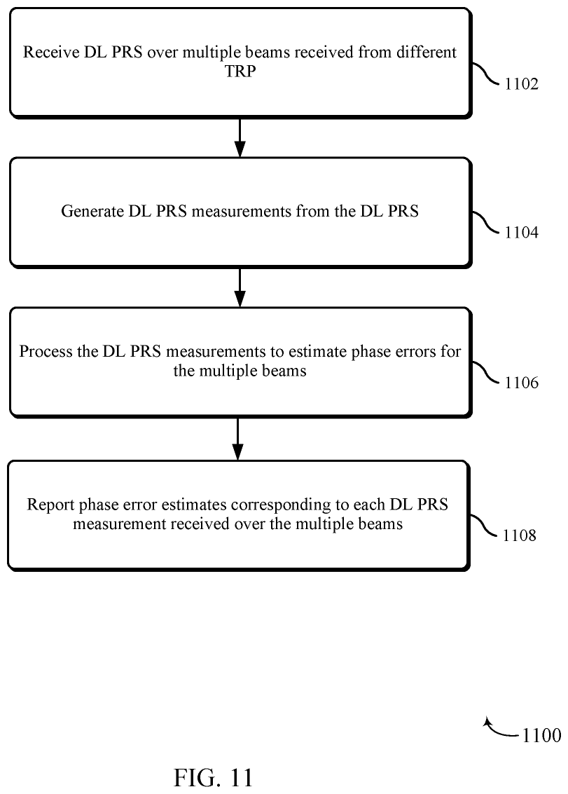

FIG. 11 illustrates a flowchart of a method 1100 that supports phase error estimate for position determination in accordance with aspects of the present disclosure. The operations of the method 1100 may be implemented by a device or its components as described herein. For example, the operations of the method 1100 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1102, the method may include receiving DL PRS over multiple beams received from different transmission-reception points (TRP). The operations of 1102 may be performed in accordance with examples as described herein. In some implementations, aspects of the operations of 1102 may be performed by a device as described with reference to FIG. 1.

At 1104, the method may include generating DL PRS measurements from the DL PRS. The operations of 1104 may be performed in accordance with examples as described herein. In some implementations, aspects of the operations of 1104 may be performed by a device as described with reference to FIG. 1.

At 1106, the method may include processing the DL PRS measurements to estimate phase errors for the multiple beams. The operations of 1106 may be performed in accordance with examples as described herein. In some implementations, aspects of the operations of 1106 may be performed by a device as described with reference to FIG. 1.

At 1108, the method may include reporting phase error estimates corresponding to each DL PRS measurement received over the multiple beams. The operations of 1108 may be performed in accordance with examples as described herein. In some implementations, aspects of the operations of 1108 may be performed by a device as described with reference to FIG. 1.

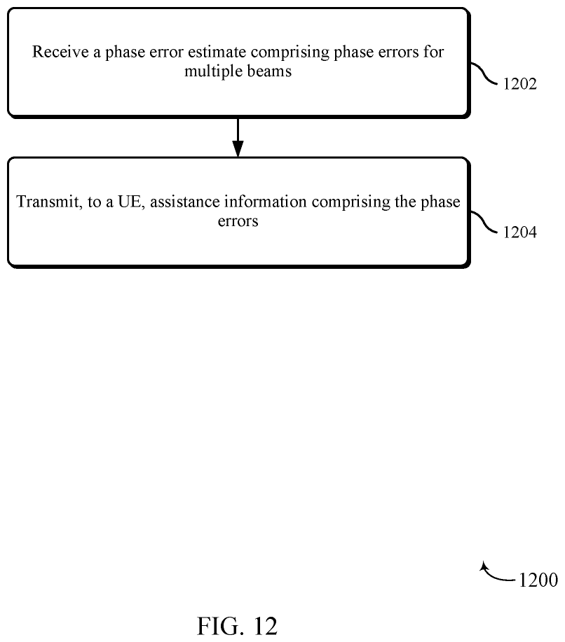

FIG. 12 illustrates a flowchart of a method 1200 that supports phase error estimate for position determination in accordance with aspects of the present disclosure. The operations of the method 1200 may be implemented by a device or its components as described herein. For example, the operations of the method 1200 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1202, the method may include receiving a phase error estimate comprising phase errors for multiple beams. The operations of 1202 may be performed in accordance with examples as described herein. In some implementations, aspects of the operations of 1202 may be performed by a device as described with reference to FIG. 1.

At 1204, the method may include transmitting, to a UE, assistance information comprising the phase errors. The operations of 1204 may be performed in accordance with examples as described herein. In some implementations, aspects of the operations of 1204 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus comprising:
at least one memory; and
at least one processor coupled with the at least one memory and operable to cause the apparatus to:
receive downlink (DL) positioning reference signal (PRS) over multiple beams received from different transmission-reception points (TRP);
generate DL PRS measurements from the DL PRS;
process the DL PRS measurements to estimate phase errors for the multiple beams; and
report phase error estimates corresponding to each DL PRS measurement received over the multiple beams.

2. The apparatus of claim 1, wherein the apparatus comprises a positioning reference unit (PRU).

3. The apparatus of claim 1, wherein the at least one processor is operable to cause the apparatus to report the phase error estimates to a network entity.

4. The apparatus of claim 3, wherein the network entity comprises a location management function (LMF).

5. The apparatus of claim 1, wherein the at least one processor is operable to cause the apparatus to report a beam indication for the multiple beams, the beam indication comprising one or more of beam identifiers, timestamps, or a timer associated with the DL PRS measurements.

6. The apparatus of claim 5, wherein the at least one processor is operable to cause the apparatus to report the beam indication to a location management function (LMF) via long term evolution positioning protocol (LPP) signaling.

7. The apparatus of claim 1, wherein the at least one processor is operable to cause the apparatus to receive a request from a location management function (LMF) for estimated phase errors, and to report the phase error estimates to the LMF via long term evolution positioning protocol (LPP) signaling.

8. The apparatus of claim 1, wherein the at least one processor is operable to cause the apparatus to report a timer indicating one or more validity times for the one or more of the DL PRS measurements or the estimated phase errors.

9. The apparatus of claim 8, wherein the at least one processor is operable to cause the apparatus to estimate the timer based on information about one or more of oscillator instability, channel conditions, or cycle slips.

10. The apparatus of claim 1, wherein the at least one processor is operable to cause the apparatus to:
process the DL PRS measurements over a period of time to estimate updated phase errors for the multiple beams; and
report an updated phase error estimate of the updated phase errors.

11. The apparatus of claim 10, wherein the at least one processor is operable to cause the apparatus to report the updated phase error estimate of the updated phase errors based at least in part on expiry of a timer.

12. The apparatus of claim 1, wherein the at least one processor is operable to cause the apparatus to process the DL PRS measurements to estimate the phase errors for the multiple beams based on one or more of initial phase offsets at the TRP, carrier frequency offsets (CFO), one or more time synchronization errors, one or more frequency synchronization errors, or one or more antenna reference point (ARP) errors.

13. An apparatus comprising:
at least one memory; and
at least one processor coupled with the at least one memory and operable to cause the apparatus to:
receive a phase error estimate comprising phase errors for multiple beams; and
transmit, to a user equipment (UE), assistance information comprising the phase errors.

14. The apparatus of claim 13, wherein the at least one processor is operable to cause the apparatus to receive a request from the UE for assistance information and transmit the assistance information based at least in part on the request.

15. The apparatus of claim 13, wherein the at least one processor is operable to cause the apparatus to transmit the assistance information to the UE via long term evolution positioning protocol (LPP) signaling.

16. The apparatus of claim 13, wherein the at least one processor is operable to cause the apparatus to:
transmit a request for the phase errors for the multiple beams to a positioning reference unit (PRU); and
receive the phase error estimate from the PRU.

17. A user equipment (UE) for wireless communication, comprising:
at least one memory; and
at least one processor coupled with the at least one memory and operable to cause the UE to:
transmit a request for assistance data for phase error mitigation;
receive the assistance data; and
estimate a position of the UE based at least in part on the assistance data.

18. The UE of claim 17, wherein the at least one processor is operable to cause the UE to:
generate downlink (DL) positioning reference signal (PRS) measurements over multiple beams; and
estimate the position of the UE via application of the assistance data to the DL PRS measurements.

19. The UE of claim 18, wherein the assistance data comprises estimated phase errors in the DL PRS.

20. (canceled)

21. A method performed by a user equipment (UE), the method comprising:
transmitting a request for assistance data for phase error mitigation;
receiving the assistance data; and
estimating a position of a user equipment (UE) based at least in part on the assistance data.
